(19) United States
(12) Patent Application Publication
(10) Pub. No.: US 2019/0308914 A1
(43) Pub. Date: Oct. 10, 2019

(54) Method of treating magnesium oxysulfate or magnesium oxychloride article with water soluble phosphate solution

(71) Applicant: Xianghua Kong, Rolling Meadows, IL (US)

(72) Inventor: Xianghua Kong, Rolling Meadows, IL (US)

(73) Assignee: Xianghua Kong, Rolling Meadows, IL (US)

(21) Appl. No.: 15/947,392

(22) Filed: Apr. 6, 2018

(51) Int. Cl. C04B 41/50; C04B 41/00

(52) U.S. Cl. CPC C04B 41/5015; C04B 41/4535; C04B 41/009

(57) ABSTRACT

This application relates to a treating method for magnesium oxysulfate cement (MOS) or magnesium oxychloride cement (MOC) articles. The MOS or MOC article is molded, cured and dried, then the article is treated in water soluble phosphate solution for periods of 0.5 to 90 minutes. When the MOS or MOC article is treated in water soluble phosphate solution, phosphate can penetrate into MOS or MOC article, react with the non-active magnesia remaining in MOS or MOC article to form magnesium phosphate cement (MPC). After such treatment, MOS or MOC phase is bonded by magnesium phosphate cement (MPC), many defects for MOS or MOC article, such as cracks, distortion, chalking, effloresce, poor durability, and so on, can be reduced or eliminated.

### TECHNICAL FIELD

The present invention relates to a process for producing magnesium oxysulfate cement (MOS) or magnesium oxychloride cement (MOC), in which the MOS or MOC particles are bonded by magnesium phosphate cement (MPC). Such hybrid magnesium cement microstructure will posses the excellent properties both of MOS and MPC and is especially useful for fire protection and building construction.

### BACKGROUND

The magnesia cements include magnesium oxychloride (MOC), magnesium oxysulfate (MOS) and magnesium phophate cement (MPC). Comparing with Portland concrete, these MgO cements posses more excellent properties, such as high strength, fire proof, mold proof, insect proof, and so on. Now most of MOS and MOC is made in Asia in the form of boards reinforced with glass fiber. These MOS/MOC boards, known simply as MgO boards on the market place, are used as wall boards, floors, tile backer boards, and other applications. Compared with MOC and MOS, MPC is not as widely used since the reaction between magnesia and phosphate occur too fast even though lots of retarder were added.

MOC has been used for many years. Sorel in 1867 announced the discovery of an excellent cement formed from the combination of magnesium oxide and magnesium chloride solution. This cement type is known by many different names, such as Sorel, magnesite or magnesium oxychloride cement (MOC). MOC has many superior properties compared to Portland cement. It does not need wet curing, has high fire resistance, low thermal conductivity, good resistance to abrasion. MOC also bonds very well to a variety of inorganic and organic aggregates, such as, saw dust, wood flour, marble flour, sand and gravel, giving a cement that has high early strength, insectcidal properties, resilient, mold resistance, and so on. The main bonding phases found in MOC cement pastes are Mg(OH)₂, 3Mg(OH)₂.MgCl₂.8H₂O (3-form) and 5Mg(OH)₂.MgCl₂.8H₂O (5-form). 5-form is the key phase with superior mechanical properties. Unfortunately, there are many disadvantages to the current MOC boards used in the construction industry, such as poor durability, effloresce, distortion, cracks, and so on. The main reason is that the magnesium oxychloride phase and remaining MgO are not stable in prolonged contact with water. A promising development illustrated by several references is the use of small quantities of phosphates to improve the stability of MOC phases. For example, Deng (Deng, D. The mechanism for soluble phosphates to improve the water resistance of magnesium oxychloride cement Cem. Concr. Res. 2003, 33, 1311-1317) investigated the effects of small phosphate additions (up to 1.7 wt % phosphoric acid, NaH₂PO₄, or (NH₄)H₂PO₄) on the properties of MOC binders during immersion in water for 60 days. Phosphates were found to greatly improve compressive strength retention: up to 96% of the dry-cured strength was retained when 0.74 wt % H₃PO₄ was added, compared to 6.4% retention for the unmodified MOC. U.S. Pat. No. 8,603,237 added various mono- or dihydrogen phosphate additives to MOC cements to try and combat this problem of water resistance. The mechanism was not attributed to the formation of insoluble magnesium phosphates; rather, it was observed that the phosphates reduced the level of free Mg²⁺ ions required in solution and thus, stabilized the 5 phase. (Tan, Y.; Liu, Y.; Grover, L. Effect of phosphoric acid on the properties of magnesium oxychloride cement as a biomaterial Cem. Concr. Res. 2014, 56, 69-74).

Magnesium oxysulfate cement (MOS) was developed after magnesium oxychloride (MOC) cement. Magnesium oxysulfates (MOS) are formulated by the reaction between magnesium oxide and magnesium sulfate solution, and like that of MOC has very good binding properties. It is difficult to prepare MOS cement due to the lower compressive strength until 2013. It has been found that a large amount of needle-like new hydration phase generates in ternary cementitious system of MgO—MgSO₄—H₂O by adding proper additives such as citric acid, which improves its strength by two to three times. This new hydration phase was determined to 5Mg(OH)₂.MgSO₄.7H₂O (5.1.7 phase) by chemical analysis, TG analysis and X-ray diffraction. (R. Tomce, C. Y. Wu, H. F. Yu, B. O. Yang, E. D. Robert, Structural characterization of new magnesium oxysulfate hydrate cement phase and its surface reactions with atmospheric carbon dioxide, J. Amer. Ceram. Soc. 96 (2013) 3609-3616.) Now the main bonding phases found in MOS cement pastes are Mg(OH)₂ and 5Mg(OH)₂—MgSO₄.7H₂O (5.1.7 phase). Researchers commonly believe that ternary cementitious system of MgO—MgSO₄—H₂O compared with MOC cement has some advantages such as better high temperature resistance, better steel-protection, not easy to absorb moisture and good water resistance. But unfortunately, there are many disadvantages to the current MOS boards too, such as poor durability, effloresce, distortion, cracks, and so on, which are same as MOC. Wu et al studied the effects of phosphoric acid and phosphates (H₃PO₄, KH₂PO₄, K₃PO₄ and K₂HPO₄) on the setting time, mechanical strength and water resistance of MOS cement. Their results show that adding phosphoric acid and phosphates can extend the setting time and improve the compressive strength and water resistance of MOS cement by changing the hydration process of MgO and the phase composition. Phosphoric acid or phosphates ionize in solution to form H₂PO₄⁻, HPO₄²⁻ and/or PO₄³⁻, and these anions adsorb onto [Mg(OH)(H₂O)x]⁺ to inhibit the formation of Mg(OH)₂ and further promote the generation of a new magnesium subsulfate phase, leading to the compact structure, high mechanical strength and good water resistance of MOS cement. The improvement produced by adding phosphoric acid or phosphates to MOS cement follows the order of H₃PO₄═KH₂PO₄>K₂HPO₄>K₃PO₄. (Wu, C.; Yu, H.; Zhang, H.; Dong, J.; Wen, J.; Tan, Y. Effects of phosphoric acid and phosphates on magnesium oxysulfate cement Mater. Struct. 2015, 48, 907-917).

Magnesium phosphate cements (MPC) can be formed through a reaction between MgO and a soluble acid phosphate, and non-active MgO (also called dead-burned MgO) is often used. MPC possess some advantages over other cementitious materials: (1) quick setting and hardening, it can be demolded within 30 min after casting; (2) high early strength, compressive strength can reach 28 MPa in 1 h and above 40 MPa in 3 h; (3) quick setting in a low temperature environment (−20° C.) without heat treatment; (4) favorable bonding strength with old concrete; (5) excellent resistance to abrasion and frost; (6) low drying shrinkage; (7) fire-proof behavior; and (8) low thermal expansion coefficient. In contrast to MOS and MOC cements, this cement system has good water and freeze thaw resistance. Compared with MOS and MOC, MPC is not as widely used since the reaction between magnesia and phosphate occur too fast to mold articles.

In summary, MOS and MOC have been used for many years and their applications are limited by their disadvantages, such as cracks, distortion, chalking, effloresce, poor durability, and so on, especially contacting with water. A very interesting phenomenon has been reported is that the properties both MOS and MOC can be improved by adding little phosphate into slurry before the article is molded. The present application relates to a method to reduce the disadvantages of MOS and MOC by treating the MOS and MOC article after it is molded.

### SUMMARY OF THE INVENTION

This application further relates to a treating method for MOS or MOC article with water soluble phosphate solution. The MOC or MOS article was molded, cured and dried, then the article was treated in water soluble phosphate solution, phosphate penetrate into MOC or MOS article, the non-active magnesia remaining in MOC or MOS article react with phosphate to form MPC. The time of immersion is at least 0.5 minute and typically ranges between 0.5 and 90 minutes.

### REFERENCE TO DRAWINGS

FIG. 1 XRD patterns of MOS cement before KH₂PO₄ solution treatment

FIG. 2 XRD patterns of MOS cement after KH₂PO₄ solution treatment

FIG. 3 MOS articles without phosphate treatment

FIG. 4 MOS articles treated with phosphate solution, exposed in exterior for 6 months.

### DETAILED DESCRIPTION

As mentioned above, MPC can be prepared by mixing MgO powders and a soluble acid phosphate together, and non-active MgO (also called dead-burned MgO) is often used. Based on the present reports, it has been demonstrated that the activity of MgO is an very important parameter for MOS and MOC, since only active MgO can convert into MOS/MOC. For example the best light burnt MgO used in MOS/MOC products made in China is called 85-MgO, in which the total MgO content is 85%, but the active MgO content is only 60˜65%, which means more than 20% of MgO was non-active MgO for MOS/MOC. These non-active MgO can react with CO₂, water in humid environment to form carbonate, Mg(OH)₂ and Magnesium carbonate hydroxide. On the other hand, during the curation of MOS or MOC, it is inevitable that MgO hydrates to form Mg(OH)₂ in parallel with the formation of the MOC or MOS phase, so the mole ratios between magnesium oxide and sulphate are more than the theoretical ratio, which means more MgO are often added into the slurry. In general, there are many Magnesium compounds for the formation of MPC. In addition, the water absorption for MOS and MOC is 20˜30 percent, which means MOS and MOC article is porous and the water soluble phophate solution can penetrate into MOS and MOC article to react with non-actice MgO. So the magnesium compounds, including MgO, MgCO₃, Mg(OH)₂ and Mg₂(OH)₂CO₃, can react with phosphate to form MPC, then the disadvanges of MOS and MOC can be reduced or eliminated.

It is well known that the excellent ductibility of MOS and MOC comes from its fiber-like micro-structure. Just like fiber reinforced cement, the hybrid cements, in which fiber-like MOS or MOC particles are bonded by magnesium phosphate cement (MPC), may be found some special properties and new applications. The detail treating method describes as follows:

Magnesium oxychloride and oxysulfate articles are formed by the intimate mixing of concentrated solutions of magnesium sulfate or magnesium chloride with magnesium oxide. MgO used to prepare MOS/MOC articles was light-burnt magnesia (LBM) powder, in which the active MgO, which can react with MgCl₂/MgSO₄, should be more than 50% so that the strength is enough to be handled. Magnesium sulfate solutions may typically contain 20 to 40 percent by weight magnesium sulfate solids. Magnesium chloride solutions used typically contain from 15 percent to 50 percent by weight solids. The mole ratios of active magnesium oxide to hydrated sulfate used to prepare magnesium oxysulfate cements are typically in the range of between 5:1 to 14:1. The mole ratios of magnesium oxide to hydrated magnesium chloride are typically in the range of 5:1 to about 8:1. It is preferred in manufacturing the magnesium oxysulfate cements to provide an oxysulfate having the formula 5MgO.MgSO₄.7H₂O. The preferred magnesium oxychloride cement is one having the formula 5MgO.MgCl₂.8H₂O. In the MOS/MOC articles, silicate, alumina, EPS, saw dust, fillers and additives can be used. In order to get more MPC after phosphate treatment dead-burnt MgO can be used as fillers since the dead burnt MgO can not react with MgCl₂/MgSO₄, but dead burnt MgO can react with phosphate quickly. The articles can also be enhanced by using glass fiber meshes and fabric non-weave cloth, and so on. The slurry prepared by mixing MgO, magnesium sulphate solution, fillers, additives, sawdusts, scrapes. In one embodiment, MOS or MOC slurry is mixed by directing magnesium chloride/magnesium sulfate, magnesium oxide, additives, fillers and water. The slurry is directed to a mold. The mold is formed with the slurry to form a MOS/MOC article. The MOS/MOC article is then cured and dried at certain temperature and humidity.

The phosphates can be selected from water soluble acid and/or salt of phosphate, pyrophosphate and polyphosphate, such as H₃PO₄, KH₂PO₄, NH₄H₂PO₄, NaH₂PO₄, Mg(H₂PO₄)₂, Al(H₂PO₄)₃, Zn(H₂PO₄)₂, Ca(H₂PO₄)₂, and so on, in which KH₂PO₄ and NH₄H₂PO₄ are preferred since MgKPO₄.6H₂O and MgNH₄PO₄.6H₂O are the most important MPC. The concentration of phosphate solution are not limited. The lower concentration means longer treating time. The preferred concentration is 0.5˜50%. Other additives, such as pH adjustment, surfactant, and so on, can be added into phosphate solution.

The treatment employed may be rendered in many ways, such as in a bath, or in a transporting line. Typically, the articles are immersed in a phosphate solution bath for the requisite time period. The bath temperature is not limited since MgO can react with phosphate quickly even in a low temperature. The time of immersion is at least 0.5 minute and typically ranges between 0.5 and 90 minutes. Soluble phosphate may be excess when treating time is too long. The articles can also be treated by spraying the phosphate solution onto the articles when they are moving in a transporting line.

The invention is exemplified by the following, non-limiting examples

### Example 1

MgO used to prepare MOS articles was light-burnt magnesia (LBM) powders with particle size of 180 mesh and provided from Liaoning province, China. Typical chemical analysis of LBM was listed in Table 1. Because only active MgO (a-MgO) can hydrate and convert to magnesium oxysulfate within the setting process of MOS cement, it is necessary to know the content of a-MgO in the LBM. The content of a-MgO used in this work was determined to be 64.10% by the standardized hydration method. Magnesium sulfate (MgSO₄.7H₂O) was analytically pure. Organic acids such as citric acid are additives. Perlite was used as fillers.

TABLE 1
Chemical Composition of Light Burnt Magnesia(LBM) Powder

| Chemical composition | MgO | CaO | SiO₂ | Fe₂O₃ | Al₂O₃ | I.L |
|---|---|---|---|---|---|---|
| Mass fraction % | 84.10 | 1.20 | 5.07 | 0.43 | 0.15 | 9.05 |

First, get ready for some MOS articles. 500 g light weight magnesia was mixed with 810 g magnesium sulfate solution with 2.5 g citric acid, the molar ratio of between a-MgO and MgSO₄.7H₂O is 5. The mixing time of the paste was 2 min. Then 80 g perlite and 50 g sawdust were added into the paste to form the slurry and further mixed for 5 min. The slurry was cast into 120×240×12 mm polyethylene molds, cured at temperature of 20±3° C. for 24 hours, after which the sample is demoulded, left in same conditions at room temperature for 7 days to make all the a-MgO react to form 5.1.7 phase, dried in open condition for 7 days.

Secondly, the MOS articles are treated in KH₂PO₄ solution bath with mass fraction 20% for 5 minutes, then these MOS articles are cured at room temperature for 24 hours, left in open condition at room temperature for 7 days, dried in open condition for 7 days. The weight gain after treating with water soluble solution is 3.2%.

The compressive strength of MOS sample was tested on a testing machine with maximum force of 300 kN according to cement strength test method standard ASTM-C109. Triplicate samples were tested. The crushed cement was reduced to a powder D90<30 μm for crystal phase composition analyzed on an X-ray diffractometer with Cu target, and XRD spectra were fitting to determine whether there are MPC after treated in soluble phosphate bath. The composition was also analyzed by X ray Fluorescence. To evaluate the water resistance of MOS specimens, specimens were dipped in water at 20±3° C. The liquid-solid mass ratio keeps at 20:1, and water was changed once every 7 days. The compressive strength of the samples after different immersion time in water was measured and used to calculate the softening coefficient.

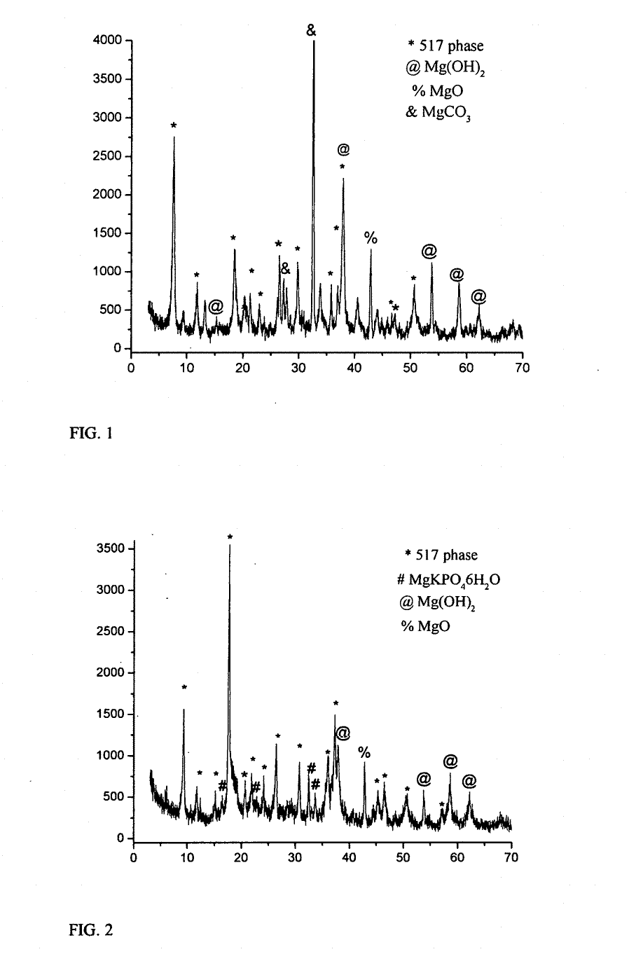

FIG. 1 shows the XRD patterns of MOS cement. As shown in FIG. 1, MOS article before treated in KH₂PO₄ solution mainly consists of 5.1.7 phase, Mg(OH)₂, MgO and MgCO₃. FIG. 2 shows the XRD patterns of MOS cement after treated KH₂PO₄ solution, peaks of MgCO₃ disappear, and the peaks of MgO and Mg(OH)₂ become lower which means the amounts of MgO and Mg(OH)₂ reduce to a low level. It also means the amount of MgO is excessive for the reaction of MPC and no water soluble phosphate leaves after the reaction finish, which is very important for MPC articles. On the other hand, the peaks of MgKPO₄.6H₂O (MPC) are found. The composition of MOS article was analysized by X ray Fluorescence and shown in Table 2. From Table 2 it can be seen that the amount of P₂O₅ is about 2.22%. Table 3 shows the compressive strength changes of MOS cement before and after phosphate treatment. The compressive strength increased 25%, the bending strength increased 30%, and softening coefficient in water 28 days increased from 0.85 to 1.03.

TABLE 2
The composition of MOS article analysized by X ray Fluorescence

| | | | | | | | | Other |
|---|---|---|---|---|---|---|---|---|
| MgO | SiO₂ | SO₃ | Al₂O₃ | P₂O₅ | K₂O | CaO | Fe₂O₃ | compositions |
| 52.7782 | 21.5181 | 10.8045 | 6.0952 | 2.2214 | 2.1462 | 1.8216 | 1.7501 | Balance |

TABLE 3
The strength changes of MOS cement
before and after phosphate treatment.

| | The | The bending | |
|---|---|---|---|
| | compressive | strength | softening coefficient in |
| MOS article | strength (MPa) | MPa | water 28 days |
| Before phosphate | 56.6 | 14.5 | 0.85 |
| treatment | | | |
| after phosphate | 71.2 | 18.9 | 1.03 |
| treatment. | | | |

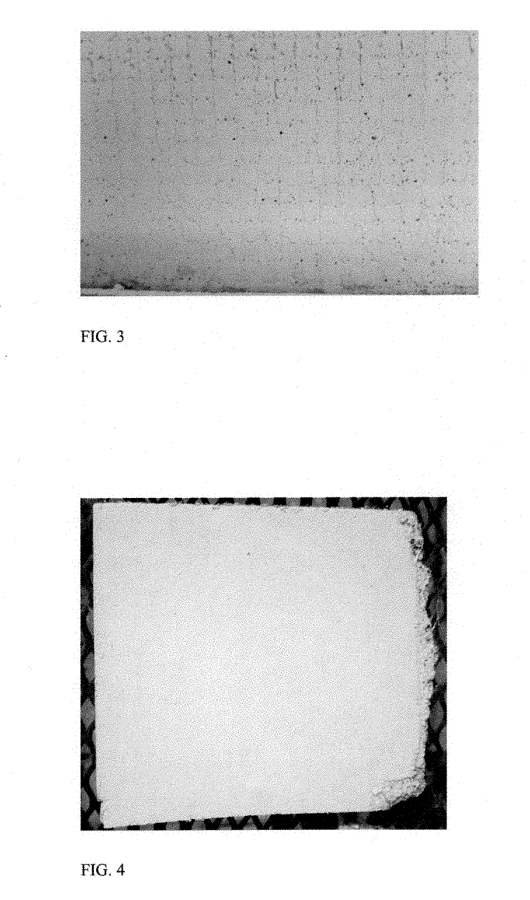

In order to evaluate the ageing stability, the MOS articles were exposed in an outdoor environment (Chicago, Ill.), starting on September, 2017. The MOS article without phosphate treatment cracks after 2 months and the picture shown in FIG. 3. FIG. 4 shows the appearance of MOS sample treated with phosphate treatment after 6 months, there is no cracks and its surface is still very smooth, even the cut edge and fracture surface show no change.

### Example 2

A MOC article is prepared by mixing a calcined caustic magnesia with particle size of 180 mesh, an aqueous solution of MgCl₂, phosphoric acid, fine sawdust and perlite, having a mix formulation expressed as MgO 32.2%, MgCl₂ 12.6%, H₃PO₄ 0.5%, fine sawdust 6%, H₂O 40.7%, and perlite 8%. After mixing by a planetary mixer for 5 minutes, the resulting slurry is cast in a mould. Curing is performed at room temperature in covered condition for 1 day, after which the sample is demoulded, left in same conditions at room temperature for 7 days, dried in open condition for 7 days. Then the MOC article is treated in KH₂PO₄ solution bath with weight concentration 20% for 5 minutes, then the MOC article is recured at room temperature for one day, left in open condition at room temperature for 7 days.

The composition of MOS article was analysized by X ray Fluorescence and shown in Table 4. From Table 4 it can be seen that the amount of P₂O₅ is about 2.76%. Table 5 shows the strength changes of MOC cement before and after phosphate treatment. The compressive strength increased 26.6%, the bending strength increased 38%, and softening coefficient in water 28 days increased from 0.72 to 0.99.

TABLE 4
The composition of MOS article analysized by X ray Fluorescence

| | | | | | | | | Other |
|---|---|---|---|---|---|---|---|---|
| MgO | SiO₂ | Cl | Al₂O₃ | P₂O₅ | K₂O | CaO | Fe₂O₃ | compositions |
| 67.7583 | 9.8172 | 13.0787 | 1.0432 | 2.765 | 1.4029 | 2.3164 | 0.9144 | Balance |

TABLE 5
The strength changes of MOC cement
before and after phosphate treatment.

| | The | The bending | |
|---|---|---|---|
| | compressive | strength | softening coefficient in |
| MOS article | strength (MPa) | MPa | water 28 days |
| Before phosphate | 52.3 | 12.5 | 0.72 |
| treatment | | | |
| after phosphate | 66.2 | 17.3 | 0.99 |
| treatment. | | | |

What is claimed is:

1. A method for improving the durability characteristics of a formed article of MOS or MOC, comprising: MOS or MOC article is treated with phosphate solution.

2. The method of claim 1, wherein MOS or MOC article are formed by the intimate mixing of concentrated solutions of magnesium sulfate or magnesium chloride with magnesium oxide. MgO used to prepare MOS/MOC articles was light-burnt magnesia (LBM) powder, in which the active MgO, which can react with MgCl₂/MgSO₄, should be more than 40%. Magnesium sulfate solutions may typically contain 15 to 40 percent by weight magnesium sulfate solids. Magnesium chloride solutions used typically contain from 15 percent to 50 percent by weight solids.

3. The method of claim 2, wherein the mole ratios of active magnesium oxide to hydrated sulfate used to prepare MOS are typically in the range of between 5:1 to 14:1. The mole ratios of magnesium oxide to hydrated magnesium chloride are typically in the range of 5:1 to about 8:1.

4. The method of claim 2, wherein dead-burnt MgO can be used as fillers, the amount of dead burnt MgO is 0˜30%.

5. The method of claim 1, wherein the phosphates can be selected from water soluble acid and/or salt of phosphate, pyrophosphate and polyphosphate, such as KH₂PO₄, NH₄H₂PO₄, NaH₂PO₄, Mg(H₂PO₄)₂, Al(H₂PO₄)₃, Zn(H₂PO₄)₂, Ca(H₂PO₄)₂, and so on, in which KH₂PO₄ and NH₄H₂PO₄ are preferred.

6. The method of claim 1, wherein the concentration of phosphate solution is 0.5˜50%, the treating time is 0.5˜90 minutes.
